(19) United States
(12) Patent Application Publication
(10) Pub. No.: US 2007/0202240 A1
(43) Pub. Date: Aug. 30, 2007

(54) Accelerated Method For Drying And Maturing Sliced Food Products

(76) Inventors: Josep Comaposada Beringues, Sagas (ES); Jacint Arnau Arboix, Girona (ES); Pere Gou Boto, Torroella De Montgri (ES); Josep Maria Monfort Bolivar, Vullpellac (ES)

Correspondence Address: RATNERPRESTIA, P O BOX 980, VALLEY FORGE, PA, 19482-0980, US

(21) Appl. No.: 10/592,219

(22) PCT Filed: Mar. 10, 2004
(86) PCT No.: PCT/IB04/00661

§ 371 Date: Sep. 8, 2006

(51) Int. Cl. A23L 1/31

(52) U.S. Cl. 426/641

(57) ABSTRACT

It includes the stages of a) Slicing that product in slices with a 5 determined thickness, b) Partially drying those slices with a pressure lower than the atmospheric pressure and, optionally, with a simultaneous energy supply, c) Applying a modified atmosphere to the 10 product, d) Maturing that sliced food product in that modified atmosphere and in a controlled temperature. This process allows to reduce considerably the time elapsed in the stages of drying and maturing food 15 products.

The present invention refers to a method for drying and maturing sliced food products.

### BACKGROUND OF THE INVENTION

The traditional method for elaborating certain food products, comprises a final stage of drying and maturing, in which takes place a reduction in the water content of the product, as well as several physical, chemical and microbiological changes that determine the organoleptic characteristics of the final product.

The traditional methods for drying and maturing are carried out by placing the whole pieces of the food product in storage rooms where the temperature and moisture are controlled. While this method is applied, it is of vital importance to ensure the microbiological stability of that product so that it does not degradate and it develops the organoleptic properties that will characterize it.

The traditional method for drying and maturing food products has the inconvenience that it takes a very long time. In the particular case of cured raw meat products, the time required for this process can vary from one to six weeks, depending on the caliber and characteristics of the product. In the case of salted meat products as cured ham and shoulder, the time required varies from three to twenty four months or even more, also depending on the characteristics of the product.

There are methods for drying food products, particularly for meat food products, that comprise the stage of slicing the food product into slices of a determined thickness, and the stage of drying those slices by means of applying a pressure lower than the atmospheric pressure and with a simultaneous heating, until that sliced food product is partially dehydrated for a later heat treatment before its consumption.

Such drying methods reduce the losses in the performance of the product and the cooking time. However, they are not designed to be applied to the process of elaborating cured raw meat products, which comprises a stage of maturing after the stage of drying.

There are also several methods for drying and maturing of whole pieces of cured raw meat products, such as cured ham, that comprise the stage of applying pressures lower than atmospheric pressure and heating, until the meat product is microbiologically stable. These methods reduce the time required for drying and maturing by a 50 to 70 percent. However, they have the inconvenience that since they are developed in full pieces of meat, they generate gradients of moisture in the piece. Also, the working pressure are over 890 mbar, so the time required for the elaboration is still very long.

Other processes for drying and maturing of whole pieces of ham, make use of cycles of pressures of 13 to 50 mbar and a microwave heating, which is carried out in an equipment designed for this. These methods, despite they reduce the time required for the process, still have the inconvenience that since they use whole pieces of meat, they generate gradients of moisture in the piece that affect the final quality of the product obtained.

### DESCRIPTION OF THE INVENTION

The objective of the present invention is to solve the abovementioned inconveniences, developing a process of vacuum drying of the food product previously sliced, followed by the maturing of the product, carried out in a modified atmosphere at a controlled temperature, achieving with this method a considerable acceleration in the process of drying and maturing.

According to this objective, the method for drying and maturing of food products of the present invention is characterized in that it comprises the stages described in claim 1.

This process allows to reduce the time elapsed in the stages of drying and maturing food products, in quantities from several weeks or months to several days, which results in a reduction in the costs of energy and elaboration of this products. Also, the moisture in the food product is homogeneously distributed in the slice, achieving an homogeneous texture and assuring the microbiologic stability in any given place of the product. The developing of oxidation and inadequate mold growth is also avoided.

Preferably, the slices have a thickness of 0.2 to 20 mm.

Advantageously, before the stage of slicing, the stage of freezing of the product is carried out.

The freezing of the product makes the mechanization of the slicing easier, being the slicing more regular and fast.

In an embodiment of the method, the partial drying of the food products is made with a pressure under 100 mbar.

Due to this vacuum pressures, the process of partial drying is fast.

Preferably, modified atmosphere conditions with low content in oxygen is applied to the food product.

Advantageously, the content of oxygen is not higher than 1%.

This low content of oxygen in the atmosphere surrounding the food product reduces the multiplication of aerobic microorganisms which can alter this products, and helps to achieve, in a short period of time, the uniformization of the texture and the aromatic development of the food product.

In an embodiment of the method, the stage of applying an environment with a modified atmosphere to the product is carried out at the moment of packaging the product.

Preferably, the packaging is carried out in a vacuumed environment.

The vacuum-packaging, with the existent equipments in the market, guarantees the reduction of oxygen content in the atmosphere that surrounds the product.

Alternatively, before or after the maturing of such food product, preferably meat products with injected flavored brine or not, it takes place the stage of applying a reduction/elimination treatment of the flora to improve the microbiological stability of the product.

Such food products can be meat products but also non meat products, as cheese and fish products, among others. Meat products can be raw but also cooked products.

In the case of raw meat products, the partial drying is carried out with a pressure lower than 75 mbar, and with a product temperature of −2° C. to 40° C., until a reduction of weight of more than 10% of the weight of the slice before the partial drying is achieved, preferably of 10% to 40%.

By maintaining the sliced product temperature in those values, the speed of evaporation is improved and the loss of heat involved in the same process of evaporation is compensated.

As an advantage, in the case of applying that drying and maturing method to cooked meat products, the temperature of the partial drying can be higher than 40° C.

Preferably, in the case of raw meat products, the stage of maturing that food product is carried out with a controlled temperature that varies from 0° C. to 40° C.

Alternatively, before the maturing of such a food product, preferably the meat food products, a high isostatic pressure treatment is carried out, to accelerate the maturing of the product.

The use of high pressures, up to 900 MPa, completes the method of the invention as it allows, on one side, the reduction/elimination of the flora to improve the microbiologic stability of the product, and on the other side, accelerating the process of development of aromas, flavors and texture, due to the selective activation of certain enzymes, which involves a faster maturing and the minimization of alterations or faults in the final product related to a high enzymatic activity (loss of color, rancidifications, etc.).

### DESCRIPTION OF PREFERRED EMBODIMENTS

For a better understanding of the invention, four examples of embodiments are explained as follows.

### Example 1

### Accelerated Process for Drying and Maturing Sliced Ham

The accelerated process for drying and maturing begins when the stage of resting or post-salting of the process of elaborating the cured ham ends. In first place, the whole piece of ham is frozen, after being boned, to facilitate the slicing. The thickness of the slice varies from 1.5 to 2 mm. After that, it takes place the partial drying of those slices by applying a pressure of 5 to 10 mbar and maintaining the product in an approximate temperature of 20° C. The time of drying will be the necessary to achieve the microbiological stability of such product, that is, when a reduction in a 25% approximately of the slice weight before the drying is obtained. After the partial drying, the ham slices are vacuum-packed and maintained in a temperature between 3° C. and 20° C. for a period of 15 days. After that period of time, the product has developed several flavor and aroma qualities that characterize the cured ham.

### Example 2

### Accelerated Process for Drying and Maturing Sliced Sausage or Salami or Hard Pork Sausage

The accelerated process for drying and maturing begins at the end of the fermentation periode of the elaboration process of cured meat products, such as sausage, salami, or hard pork sausage. Firstly, the meat product is frozen to facilitate the slicing. The slice thickness varies from 1.5 to 2 mm. After that, it takes place the partial drying of those slices by applying a pressure of 5 to 10 mbar and by maintaining the product in an approximate temperature of 20° C. The time of drying will be the necessary to achieve the microbiological stability of the product, that is, when a reduction in the slice weight in a 30% approximately of the weight before the drying is achieved. After the partial drying, the slices are vacuum-packed and maintained in a temperature of 4° C. for 7 days. After that period of time, the product has developed the characteristic flavor and aroma of the cured meat products.

### Example 3

### Accelerated Process for Drying and Maturing Sliced Marinated-Injected Products with a Reduced Maturity Period

The accelerated process for drying and maturing is carried out when the massage stage of the elaboration process of marinated-injected products ends. Firstly, the piece of injected meat is frozen to make the slicing easier. The thickness of the slice will be of 2 to 2.5 mm. After that, it takes place the partial drying of the those slices by applying pressures that vary of 5 to 10 mbar and by maintaining the product in an approximate temperature of 20° C. The drying time is necessary to obtain the microbiological stability of the products so that it is possible to continue with a reduced maturity stage, that is, when a reduction in the slice weight in a 35% approximately of the weight before the drying is achieved. After the partial drying, the marinated-injected product slices are vacuum-packed and they are maintained in a temperature of 4° C. for a period of 15 days approximately. After that period of time, the vacuum-packed product can also have a treatment for reducing or eliminating the microbial flora in order to achieve a better stability of the matured product.

### Example 4

### Process for Drying and Maturing Food Products with Re-Structuring Agents

The preparation of food products with re-structuring agents is carried out with the following stages:
a) Mixing with one or several re-structuring agents, among which we can find:

1. Action of acids, either for the hydrolysis of lactones (i.e. Gluconodeltalactone), or the direct action of acids like lactic acid.

2. Action of transglutaminase.

3. Action of fibrinogen in the presence of thrombin.

4. Action of alginate with calcium.

5. Polyphosphates.

6. Proteins (gluten, caseinate, soya).
b) Filling with high vacuum machines to facilitate the ulterior interaction of the proteins.
c) Treatment, if necessary, with a pressure higher than atmospheric pressure, up to 900 MPa, to increase the binding.

The accelerated process of drying and maturing is initiated when the stage of preparation of products developed with re-structuring agents has finished. In first place, the product is frozen to facilitate the slicing. The thickness of the slice is from 1 to 2 mm. After that, the partial drying of such slices is carried out applying pressures from 0.1 to 10 mbar and keeping the product in a temperature of approximately 20° C. The time of drying will be the necessary until achieving the desired degree of moisture, which usually goes from 10 to 40% of reduction of weight before the drying process take place. After finishing the drying process, the slices are shaped when necessary and packed, either in a vacuum or protected atmosphere. The packed product is kept at temperatures from 3° to 20°, during a period of time lower than 48 hours. After this period of time the product has developed the characteristic flavor and aroma of the cured food product. An alternative treatment for the reduction/elimination of microbial flora can be applied to the product to stabilize it.

It is important to highlight that the application of the process of the invention to products developed with re-structuring agents allows the stage of maturing to be carried out in a short period of time, and even being unnecessary such a stage.

The process of preparation of meat food products developed with re-structuring agents allows to eliminate the stage of fermentation from the method for the elaboration of cured meat products, as well as adjusting the acidity and the content of salt of the product. The elimination of the stage of fermentation can involve a reduction in the time of up to three days in the elaboration of cured meat products. Due to the method of the invention, we must add the reduction of time during the stages of drying and maturing of the food product to the reduction of time in the stage of fermentation. The result is a method for the elaboration of meat food products with a final result equivalent to the traditional method of fermented products, which allow to reduce the costs of investment in infrastructure and processing for such products.

Despite we have described and represented four specific embodiments of the present invention, the person skilled in the art can introduce variants and modifications in this field, or substitute the details for others which are equivalent, without departing from the scope of protection defined by the enclosed claims.

1. A method for drying and maturing food products, comprising:
a) Slicing that product in slices with a determined thickness,
b) Partially drying those slices with pressure lower than the atmospheric pressure and, optionally, with a simultaneous energy supply,
c) Applying a modified atmosphere to the product, and
d) Maturing that sliced food product in that modified atmosphere and in a controlled temperature.

2. The method according to claim 1, wherein in a), the slices have a thickness between 0.2 and 20 mm.

3. The method according to claim 1, wherein, before a), the product is frozen.

4. The method according to claim 1, wherein b), is carried out with a pressure lower than 100 mbar.

5. The method according to claim 1, wherein c) is carried out with a modified atmosphere with a low oxygen content.

6. The method according to claim 5, wherein the content of oxygen in the modified atmosphere is not higher than 1%.

7. The method according to claim 1, wherein c) is carried out when packaging the product.

8. The method according to claim 7, wherein the packaging is made in a vacuum environment.

9. The method according to claim 1, wherein, before or after d), it takes place a treatment for the reduction or elimination of the flora to improve the microbiological stability of the product.

10. The method according to claim 1, wherein the food products are meat products.

11. The method according to claim 10, wherein the meat products are raw products.

12. The method according to claim 1, wherein b) is carried out with a pressure lower than 75 mbar and with a temperature of −2° C. to 40° C.

13. The method according to claim 1, wherein d) is carried out in a controlled temperature of 0° C. to 40° C.

14. The method according to claim 1, wherein, before d), an isostatic high pressure treatment is carried out to accelerate the maturing of the product.

15. Method according to claim 11, wherein b) is carried out with a pressure lower than 75 mbar and with a temperature of −2° C. to 40° C.

16. Method according to claim 11, wherein d) is carried out in a controlled temperature of 0° C. to 40° C.
